(19) United States
(12) Patent Application Publication
(10) Pub. No.: US 2003/0038777 A1
(43) Pub. Date: Feb. 27, 2003

(54) Interactive display system

(76) Inventors: Lorna Goulden, Amsterdam (NL); Paul McGroary, Eindhoven (NL); Bertrand Rigot, Eindhoven (NL); Ko Be Deu Ro, Eindhoven (NL); Nathalie Schaap, Eindhoven (NL); Alexandra Indriani Tulusan, Bayreuth (DE)

Correspondence Address: U S Philips Corporation, Intellectual Property Department, 580 White Plains Road, Tarrytown, NY, 10591, US

(21) Appl. No.: 10/221,916

(22) PCT Filed: Jan. 29, 2002
(86) PCT No.: PCT/IB02/00287

(30) Foreign Application Priority Data
Feb. 2, 2001 (EP) 01200391.9

(51) Int. Cl. G09G 5/00

(52) U.S. Cl. 345/156; 345/169

(57) ABSTRACT

Display systems are known on a lot of different places, for example at railway stations, bus stations, airports etc to display departure information.

The invention provides a new interactive display system to make the travelling much more exciting especially during waiting times.

This is achieved to add to for example a ticket a portable transmitter, which supplies signals to a receiver for displaying an image on a display means. Each traveler adds in this way information to the displayed image and makes his/her travelling less anonymous.

The invention relates to an interactive display system.

The invention further relates to a method for interactively displaying images.

An interactive display system and a method for interactively displaying images are known, and are used at a lot of different places. For example at railway stations to display the depart times of trains, airports, etc.

One of the objects of the invention is to obtain a new kind of interactive display system. To this end an interactive display system according to the invention comprises the features of claim 1.

The invention is based on the insight that travelling people for example at railway stations, underground, bus stations, airport, etc. are until now very much anonymous which makes the travelling not very much exciting.

By using an interactive display system according to the invention the places where the travelling people are for example waiting on their means of transport can be made much more exciting.

One of the main ideas of the invention is that the travelling people when buying a ticket for the means of transport they not only get the ticket but receive also a portable transmitting means which is activated for example by passing through a gate and resulting in an image on the display means.

Each traveler adds in this way something to the display means creating an overall image. Further it is for example possible that a traveler who travels each day gets another transmitting means than a traveler who travels only once which can for example be indicated on the display means by different colors.

Embodiments of the invention are described in the dependent claims.

These and other aspects of the invention will be elucidated on the basis of the not limiting examples as described hereinafter on the basis of the figures. Herein shows:

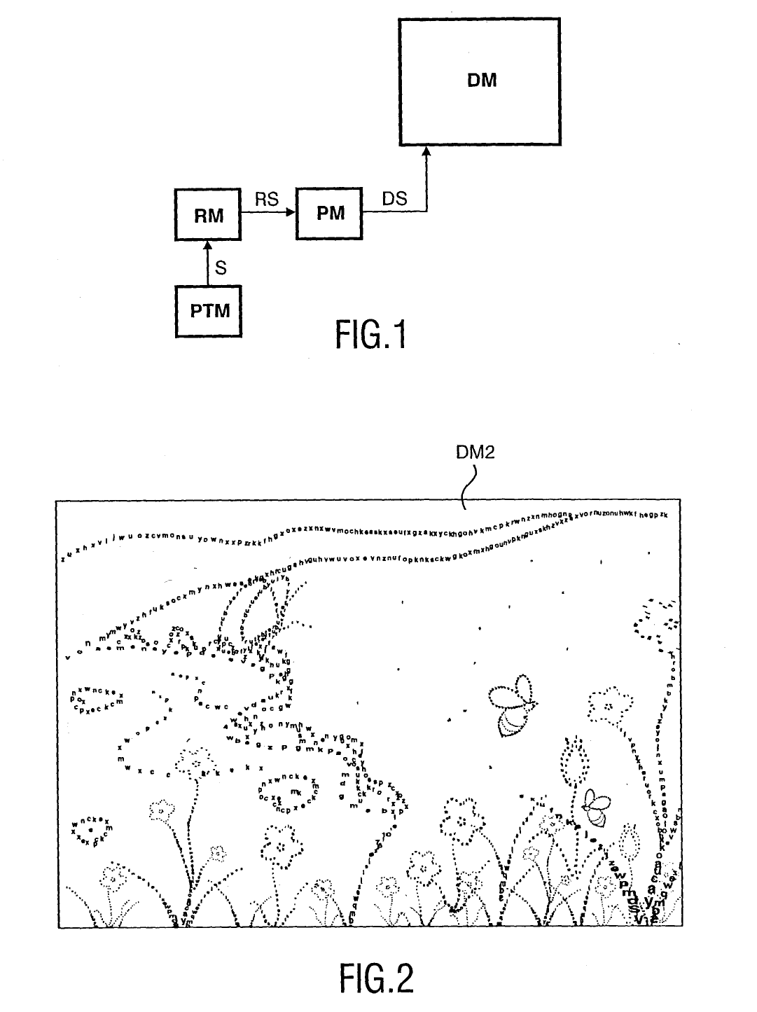

FIG. 1 a first example of an interactive display system according to the invention;

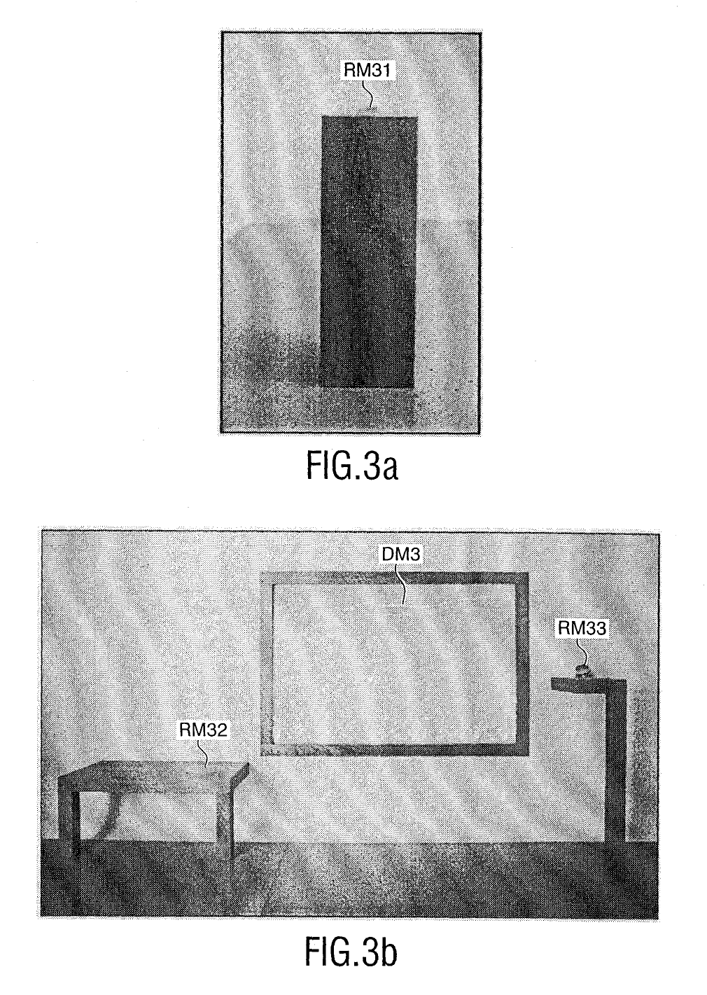

FIG. 2 a display means for use in an interactive display system according to the invention; and

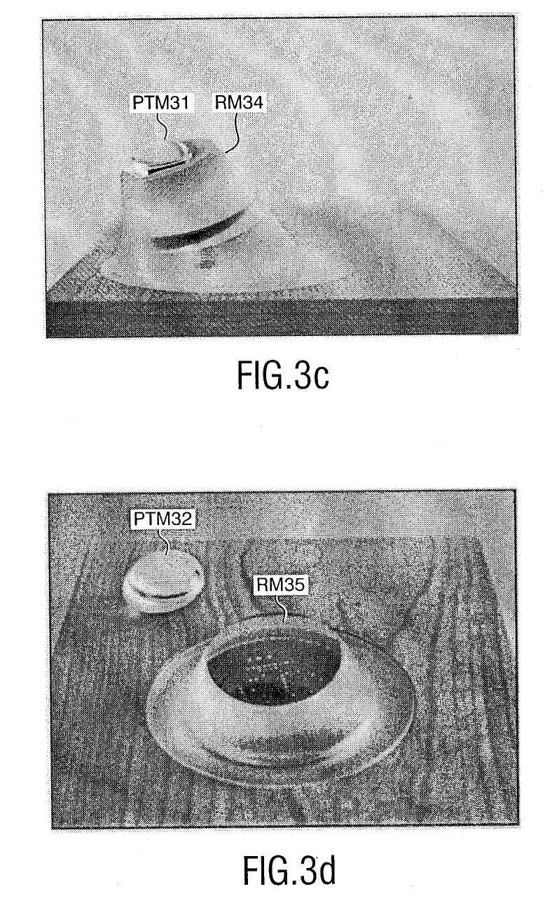

FIG. 3 examples of receiving means and portable transmitting means according to the invention.

FIG. 1 shows schematically an interactive display system IDS according to the invention. This interactive display system comprises display means DM for displaying images. The interactive display system further comprises portable transmitting means, which are to be carried for example, a traveler on a railway station. The portable transmitting means sends a signal to receiving means RM which receiving means received the transmitted signal S and supplies a received signal rs to processing means PM. The processing means processes the received receiving signal and supplies a display signal ds to the display means. The transmitting of the signal S from the portable transmitting means PTM to the receiving means RM can be activated by passing a gate. For example the same gate as which has to be passed with the ticket of the transporting means.

It is also possible that the portable transmitting means can be used actively by the traveler to create another and/or more images on the display means to be actively involved by the displaying.

FIG. 2 shows an example of display means whereby the images are built up with characters.

FIG. 3 shows examples of elements of the display system whereby

FIG. 3a shows a receiving means on which the traveler actively put it portable transmitting means to create figures on the display means.

FIG. 3b shows two other examples of receiving means RM32 and RM33 in combination with a display means DM3. The receiving means RM32 are built in a bench on which the traveler can sit. The receiving means RM33 is positioned on a high stool next to which the traveler can stand and put its portable transmitting means on the receiving means.

FIG. 3c shows another receiving means RM34 with a portable transmitting means PTM31 put on the receiving means, and

FIG. 3d shows the portable transmitting means PTM32 and receiving means RM35 separate.

The above described interactive display means can as the man skilled in the art is well aware of the amended without departing from the scope of the invention. As explained above this interactive display means can be used on railway stations, bus stations, airport but also for example in waiting rooms in a library, a town-hall, post office but also in other public places such as car repair places etc.

1. Interactive display system comprising display means for displaying images, portable transmitting means for transmitting signals to receiving means which transmitting means are to be carried by users of the display system, the receiving means for receiving the transmitted signals, and processing means for processing the received signals and supplying display signals to the displaying means.

2. Interactive display system as claimed in claim 1, characterized in that, the portable transmitting means are coupled to tickets which the users will carry.

3. Portable transmitting means for use in an interactive display system as claimed in claim 1.

4. Transmitting means for use in an interactive display system as claimed in claim 1.

5. Method for displaying images having a step of transmitting signals, receiving the transmitted signals, processing the received signals, supplying the processed signals, and displaying images on the basis of the supplied signals.
